(19) United States
(12) Patent Application Publication
(10) Pub. No.: US 2026/0147316 A1
(43) Pub. Date: May 28, 2026

(54) METHOD FOR MANUFACTURING HOROLOGY APPLIQUES

(71) Applicant: Universo S.A., La Chaux-de-Fonds (CH)

(72) Inventor: Duc Thuyet Nguyen, Marin-Epagnier (CH)

(73) Assignee: Universo S.A., La Chaux-de-Fonds (CH)

(21) Appl. No.: 19/312,597

(22) Filed: Aug. 28, 2025

(30) Foreign Application Priority Data
Nov. 22, 2024 (EP) 24214927.6

(51) Int. Cl. G04D 3/00; B23K 26/38; G04B 19/04

(52) U.S. Cl. CPC G04D 3/0046; B23K 26/38; G04B 19/042

(57) ABSTRACT

A strip, made of the material of the appliques to be manufactured, includes rows of pilot holes with at least one group of openings arranged between the rows. The openings surround a central portion of the strip material, such that the central portion remains attached to the strip. The central portion is subjected to stamping to form the applique. The openings are configured such that the stamping tool causes the material of the central portion to creep without distorting the pilot holes, producing a distorted part that remains attached to the strip. On a face of the distorted part, the applique is formed in relief relative to the face. The strip is fed through a blanking tool that blanks the applique, thereby separating it from the distorted part. The undistorted pilot holes enable the part to be positioned relative to the blanking tool.

### CROSS REFERENCE TO RELATED APPLICATIONS

This application claims priority to European Patent Application No. 24214927.6 filed Nov. 22, 2024, the entire contents of which are incorporated herein by reference.

### TECHNICAL FIELD

The invention relates to the field of horology, in particular to the production of appliques to be attached to the surface of a watch dial for the purpose of indicating the hours or for fitting other signs or symbols.

### TECHNOLOGICAL BACKGROUND

Different methods have been developed for making appliques. In terms of production speed, continuous methods have proven effective. These include methods according to which a strip is machined in a series of steps, ending with the blanking of several appliques.

One method which is now applied uses a steel strip in which pilot holes are pierced along the rims of the strip, with openings arranged in series between the rows of pilot holes. Workpieces of the applique material, often gold or brass, are driven into the openings. The strip containing the workpieces is then guided through the pilot holes, relative to a stamping tool that distorts the workpieces according to the desired shape of the appliques. The strip is then fed through a blanking tool that will blank the appliques. The workpieces are then stripped from the steel strip, which can then be reused in the same process.

As the steel strip is stronger than the workpiece material, this process makes it possible to avoid distorting the pilot holes during the stamping and blanking steps. There are nevertheless several drawbacks to this approach. The steel strip is very hard and difficult to work. However, producing the pilot holes and openings requires powerful machinery and the tools used to work the steel strip break quickly and cannot withstand the forces applied when blanking and piercing. As it is being distorted by stamping, the workpiece undergoes considerable strain, which can cause the steel strip to crack. Ultimately, the openings provided for the workpieces become distorted after several uses of the steel strip, which limits the useful life of this type of strip.

### SUMMARY OF THE INVENTION

The invention aims to provide a method that does not have the drawbacks identified in the previous paragraph. This objective is achieved by a method according to the attached claims.

According to the invention, a strip is used that is uniformly made of the material of the appliques to be manufactured. The strip is provided with rows of pilot holes along its longitudinal rims and with at least one group of openings arranged between said rows. In practice, several identical groups of openings are equidistantly provided in the longitudinal direction of the strip. The openings in a group surround a central portion of the strip material, such that the central portion remains attached to the strip by attachments formed by narrow zones in the strip between two adjacent openings. Said central portion is then subjected to a stamping step to form the applique. The dimensions and form of the openings are configured such that the stamping tool causes the material of the central portion to creep without distorting the pilot holes, thus producing a distorted part that remains attached to the strip by attachments. At the same time, on one of the faces of said distorted part, the applique is formed in relief relative to said face, preferably accompanied by attachment feet on the opposite face. The strip is then fed through a tool used for blanking, for example by stamping or using a laser, that blanks the applique, thereby separating it from the distorted part. The undistorted pilot holes enable the workpiece to be precisely positioned relative to the blanking tool.

The method enables continuous in-line work from the raw material to the released appliques, thus avoiding the use of a steel strip. Due to the shape of the central portions defined by the openings, which absorb the distortion during stamping, the pilot holes in the strip are not distorted and guarantee optimum positioning, which is also ensured by the fact that the distorted part remains attached to the strip after stamping. These differences in comparison with existing technologies enable the method according to the invention to reduce manufacturing costs and times.

### BRIEF DESCRIPTION OF THE FIGURES

The invention will be described in greater detail below with reference to the appended drawings, which are given by way of non-limiting examples, in which:

FIG. 1 shows a front view of a strip made of horology applique material, provided with holes and openings according to one embodiment of the invention.

FIG. 2 shows an example of an applique made from the strip shown in FIG. 1.

FIGS. 3a to 3b show enlarged views of part of the strip. FIG. 3a shows the strip before it is distorted by stamping. FIGS. 3b and 3c respectively show the two faces of the strip after distortion by stamping.

FIG. 4 shows a 3D view of the strip after a number of appliques have been formed by stamping, but before the blanking step.

FIG. 5 shows the part of the strip shown in FIGS. 3a-3b, after the appliques have been blanked.

FIG. 6 is an illustration of a process that uses a configuration of blanking punches to produce the strip provided with pilot holes and openings according to FIG. 1.

### DETAILED DESCRIPTION OF THE INVENTION

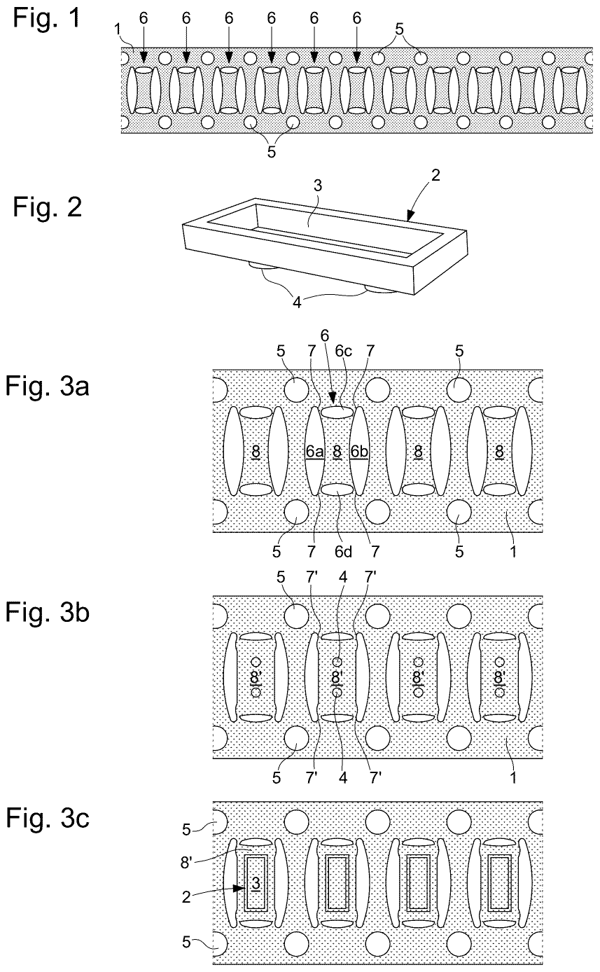

FIG. 1 shows a strip 1 made of a material that can be used for watch appliques, for example brass or another copper-based alloy. Any other material suitable for the manufacture of appliques can be used, such as gold, silver or alloys thereof.

The strip was provided with a number of holes and openings according to one non-limiting embodiment of the invention. The applique to be manufactured in this example is shown in FIG. 2. This is a rectangular-shaped applique 2 with a central bed 3 and two feet 4 on the lower face which will be used to attach the applique to a watch face. However, the dimensions of the applique 2 are adapted to the dimensions of said dial, so that the applique can appear as a time index or as a decorative element. As a result, the strip 1 is similarly dimensioned, for example with a width of between 10 and 40 millimetres. The strip dimensions can be similar to the dimensions of the steel strips with driven-in workpieces, as described in the introduction. According to one non-limiting embodiment, the thickness of the strip 1 can be between 0.3 and 1.5 mm.

Equidistant pilot holes 5 are pierced or blanked along the rims of the strip 1. These holes 5 are located and dimensioned to enable the strip 1 to be guided by the insertion of the guide teeth of a strip feeder, the movement of which will convey the strip through various tools.

Between the two rows of pilot holes 5, the strip 1 is provided with several groups 6 of openings, the groups 6 being identical to each other and equidistantly positioned in the longitudinal direction of the strip 1.

FIG. 3a shows a detailed view of part of the strip 1. According to the non-limiting embodiment shown, each group of openings 6 comprises 4 ellipse-shaped openings. The long axes of openings 6a and 6b are oriented perpendicular to the longitudinal direction of the strip 1, while the long axes of openings 6c and 6d are oriented parallel to said longitudinal direction. The length of openings 6c and 6d is less than the length of openings 6a and 6b, and the short openings 6c, 6d are between the ends of the long openings 6a, 6b, while remaining separated from the latter by attachments 7. The attachments 7 are defined by narrow zones on the strip 1 that are between two adjacent openings, for example between 6a and 6c or between 6b and 6d. As a result, openings 6a-6d surround a central portion 8 of the strip having rims in the shape of concave curves, said curves being defined by outline sections of openings 6a-6d.

The dimensions and placement of openings 6a-6d in each group 6 are determined such that the central portion 8 can be distorted by plastic distortion in a specific and predefined manner, by a stamping tool as used in the prior method described in the introduction. This tool will compress the central portions 8 between a die and a punch, configured to form the applique 2. Openings 6a-6d are configured such that the material of the central portion 8 becomes distorted without detaching the attachments 7 and without distorting the pilot holes 5.

This result is illustrated in FIGS. 3b and 3c, which show the two faces of the strip 1 after the stamping applied to each of the central portions 8. Stamping distorted the central portions 8, consisting of distorted parts 8′. Due to the profiles of the die and the punch, the feet 4 of the applique are formed on the upper face of the distorted part (FIG. 3b), in relief relative to the upper face, and the applique 2 itself, provided with the bed 3, is formed on the lower face (FIG. 3c), in relief relative to said lower face. Outside the applique, the stamping has caused the material to creep, such that the surface of the distorted part 8′ is enlarged relative to the surface of the central portion 8 before distortion. It can be seen that the outline sections of ellipses 6a-6d that surround the central portion 8 have been pushed outwards, but that the remainder of said outlines has remained essentially intact. In other words, openings 6a-6d absorbed the deformation. Therefore, the pilot holes 5 were not deformed. Moreover, after distortion, the distorted part 8′ is still attached to the strip by attachments 7′ which may be slightly distorted relative to the original attachments 7, but which maintain the uniformity of the part 8′ with the strip 1. In other words, the attachments 7 have not been broken or ruptured as a result of the forces generated by the stamping.

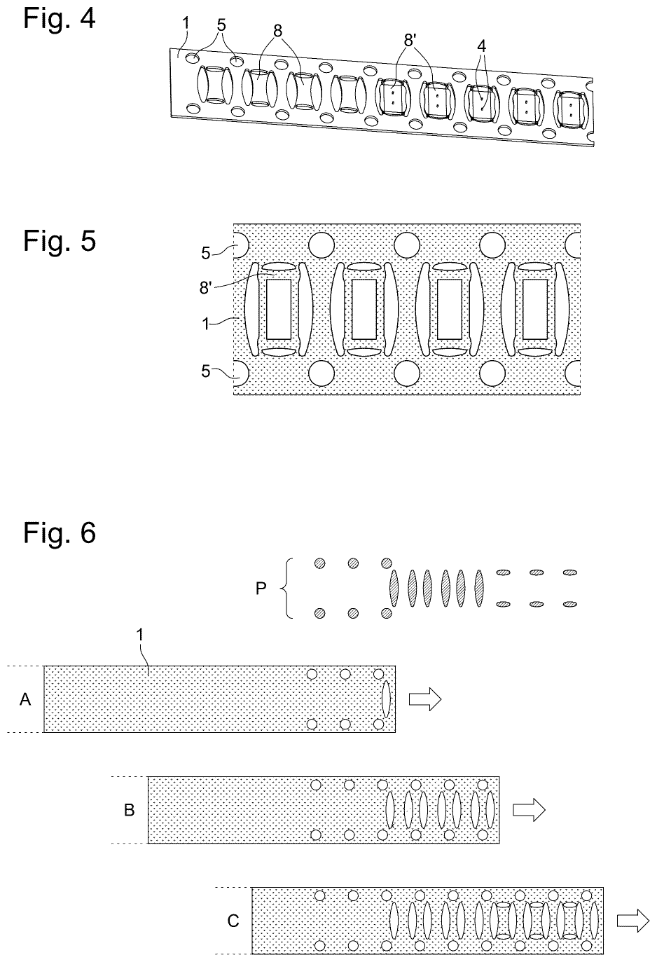

FIG. 4 shows a 3D view of a non-limiting embodiment of the strip 1, of which several central portions 8 have fed through the stamping tool, forming distorted parts 8′. The shape of the distorted parts 8′ is slightly different relative to the flat parts 8′ shown in FIGS. 3b and 3c. In FIG. 4, it can be seen that the ends of the distorted parts 8′ are bent slightly upwards. These variants are entirely equivalent, and in both cases the stamping is carried out without distorting the pilot holes 5 and without breaking the attachments 7.

After stamping, the distorted parts 8′ undergo a blanking step to separate the appliques 2 from the distorted parts 8′. The undistorted pilot holes allow for precise positioning of the parts 8′ relative to the blanking tool. FIG. 5 shows the part of the strip 1 also shown in FIGS. 3a-3c, after blanking. The tool used could be a laser cutting machine or a stamping tool similar to the stamping tool but which has a die and a blanking punch. These blanking processes are well known and are also used or can be used in the method described in the introduction. In the stamping process, the punch has a clearance that allows the foot or feet 4 of the appliques 2 to pass through. The die matches the shape of the applique and holds the applique in place during blanking. An extractor in the die then ejects the blanked applique.

To arrive at a configuration of openings that achieves the desired result, namely producing the appliques 2 without distorting the pilot holes 5 and without rupturing or breaking the attachments 7, the person skilled in the art can follow the methodology described below.

First, a number of parameters are gathered, comprising:
the material to be used,
the width and thickness of the strip,
the shape and dimensions of the applique,
the diameter and spacing of the pilot holes.

Based on these parameters, a configuration of openings is determined using simulation software to calculate the distortion of a part worked by a stamping tool. Examples of commercially-available software that can be used to arrive at the invention include Forge® (produced by Transvalor) and Abaqus (produced by Dassault Systèmes).

Starting with an initial configuration obtained, for example, on the basis of experience or of preliminary calculations, the software can simulate the forces applied by the tools used in the process and derive from the simulation the distortions in the strip under the influence of these forces. The result enables the configuration to be optimised so as to minimise distortions in the vicinity of the pilot holes and to optimise the distortion of the attachments to prevent them from breaking, by repeating the simulation several times, each time improving the shape and dimensions of the openings. Optimisation can be achieved using the simulation software, or optionally using other calculation software that is well known to the person skilled in the art.

It should be noted that the invention is not limited to the configuration shown, consisting of 4 ellipse-shaped openings. The number of openings surrounding the central portion 8 can be different, for example 3, 5 or more. The shape of the openings can be other than ellipsoidal, for example circular or rectangular, or a combination of differently-shaped openings can be applied. Outlines that provide a central portion with concave rims relative to the centre of the central portion (such as portion 8 shown in the figures) are preferred embodiments, but this type of outline is not limited to ellipsoid openings. The concave rims of the central portion can also be made by applying openings with other outlines, such as circular outlines.

Determining the optimal configuration depends on a number of parameters, including the shape and dimensions of the applique, the strip material and the shape and dimensions of the pilot holes. It should be noted that these pilot holes could have a shape other than circular (for example, rectangular or other).

The invention is not limited to one or more of the specific materials in the strip 1. Nevertheless, the preferred materials are the ones most commonly used to manufacture watch appliques, in particular copper and copper alloys such as brass, as well as gold or silver or gold or silver alloys.

Well-known methods can be used to produce pilot holes 5 and elliptical or other opening configurations. The specific case of the strip 1 shown in FIG. 1 can be achieved by blanking a strip in 3 steps repeated several times, as shown in FIG. 6. The sections of a group of blanking punches are illustrated in part P of the drawing. A strip 1, for example made of brass, is fed underneath the group of punches with different forms, which simultaneously blank any material that is presented. This type of tool is known as a progressive stamp. To obtain all the pilot holes and ellipsoid openings, three blanking steps A, B and C are required, followed each time by precise advancement of the strip in the direction of the arrows. By repeating these three steps several times, a strip with a plurality of equally spaced holes and openings is produced.

1. A method for manufacturing at least one horology applique (2), the applique being made of a predefined material, the method comprising:
providing a longitudinal strip (1) of said material, the strip being bordered by two parallel rims,
blanking or piercing rows of equidistant pilot holes (5) along each rim of the strip (1),
centrally between said rows of pilot holes, blanking or piercing at least one group of openings (6) such that outline sections of said openings define the rims of a central portion (8) made of said material, said central portion remaining attached to the strip by attachments (7) defined by narrow zones in the strip that are between two adjacent openings,
then, using the pilot holes (5), guiding the strip through a stamping tool,
using the stamping tool, simultaneously carrying out at least the following actions:
causing the material of said portion (8) to creep without distorting the pilot holes (5), so as to produce a distorted part (8′) that remains attached to the strip by attachments (7′),
on one of the faces of said distorted part (8′), producing the applique (2) in relief relative to said face,
then, using the pilot holes (5), guide the strip through a blanking tool,
feeding the part (8′) through the blanking tool, to blank the applique (2).

2. The method according to claim 1, wherein said rims on the central portion (8) have a concave shape relative to the centre of said central portion.

3. The method according to claim 1, wherein said openings (6a-6d) are elliptical in shape.

4. The method according to claim 3, wherein the group consists of 4 ellipse-shaped openings (6a-6d), comprising two openings (6a, 6b) with the long axes of the contour oriented perpendicular to the longitudinal direction of the strip (1) and two openings (6c, 6d) with the long axes of the outline oriented parallel to said longitudinal direction.

5. The method according to claim 1, wherein the strip (1) comprises a plurality of said groups of openings (6), equidistantly arranged in the strip, to produce a plurality of said central portions (8), and from these central portions (8), a plurality of appliques (2).

6. The method according to claim 1, wherein, using the stamping tool and simultaneously with said actions of producing the distorted part and the applique in relief relative to said face, one or more attachment feet (4) are formed on the face of said distorted part (8′) opposite the face on which the applique (2) is formed in relief.

7. The method according to claim 1, wherein said material of the applique (2) is copper, gold, silver, or a copper, gold or silver alloy.

8. The method according to claim 1, wherein the blanking tool is a laser blanking tool or a stamping tool using a die and a blanking punch.
